(19) United States
(12) Patent Application Publication
(10) Pub. No.: US 2008/0168861 A1
(43) Pub. Date: Jul. 17, 2008

(54) Slotted shift lever plug with multiple pivot positions

(76) Inventors: Daniel B. Teixeira, Indianapolis, IN (US); Aaron N. Dearinger, Fishers, IN (US)

Correspondence Address: CANTOR COLBURN, LLP, 20 Church Street, 22nd Floor, Hartford, CT, 06103, US

(21) Appl. No.: 11/654,279

(22) Filed: Jan. 17, 2007

(51) Int. Cl. F02N 15/02

(52) U.S. Cl. 74/7 R; 74/6

(57) ABSTRACT

Disclosed is an improved starter motor with multiple shift lever pivot positions. The improved starter motor includes a solenoid, a drive assembly located at least partially within a housing, and a shift lever linking the drive assembly to the solenoid and is in operable communication with a pivot pin. The improved starter motor includes a shift lever plug that is receptive of the pivot pin and is engageable with the housing. The shift lever plug includes one or more slot features providing a plurality of pivot points for the shift lever.

### BACKGROUND OF THE INVENTION

The present invention relates generally to a starter motor for starting an internal combustion engine. More specifically, this invention relates to an improved shift lever plug mechanism of a starter motor.

Starter motors are provided with a drive assembly and a solenoid contained in a housing. A shift lever extends between the drive assembly and the solenoid, and pivots about a pivot pin inserted through a hole in the shift lever. The pivot pin is held in place by a shift lever plug, which contains a circular hole into which the pivot pin is inserted, establishing a single pivot point for the shift lever. When the shift lever is rotated about the pivot point, a pinion gear of the drive assembly is moved into mesh with a flywheel of the engine.

Statistical variation in the manufacture of the solenoid, the manufacture of the drive assembly, and assembly of the starter motor is not sufficiently taken into account in single pivot point designs, however. The manufacturing variation can cause increased stress on the shift lever not allowing it to meet its useful life requirements, and the variation may cause restriction in movement of the shift lever which can lead to, for example, the pinion gear and the flywheel not meshing correctly.

What is needed is a starter motor pivot that takes statistical variation of starter motor components into account, thereby allowing the starter motor to achieve its life requirements, and preventing malfunction of the starter motor.

### SUMMARY OF THE INVENTION

The present invention solves the aforementioned problems by providing an improved starter motor with multiple shift lever pivot positions. The improved starter motor includes a solenoid, a drive assembly located at least partially within a housing, and a shift lever linking the drive assembly to the solenoid. The shift lever is in operable communication with a pivot pin. The starter motor includes a shift lever plug that is engageable to the housing and that includes one or more through slot features that are receptive of the pivot pin. The through slot features are configured to provide multiple potential pivot points for the shift lever.

### DESCRIPTION OF THE DRAWINGS

The above, as well as other advantages of the present invention, will become readily apparent to those skilled in the art from the following detailed description of preferred embodiments when considered in the light of the accompanying drawings in which:

FIG. 1 is a perspective view of an example of a starter motor.

FIG. 2 is a perspective view of an example of a shift lever plug of the starter motor of FIG. 1.

FIG. 3 is a side view of the shift lever plug of FIG. 2.

FIG. 4 is a perspective view of the shift lever and the shift lever plug of the starter motor of FIG. 1.

### DETAILED DESCRIPTION OF THE INVENTION

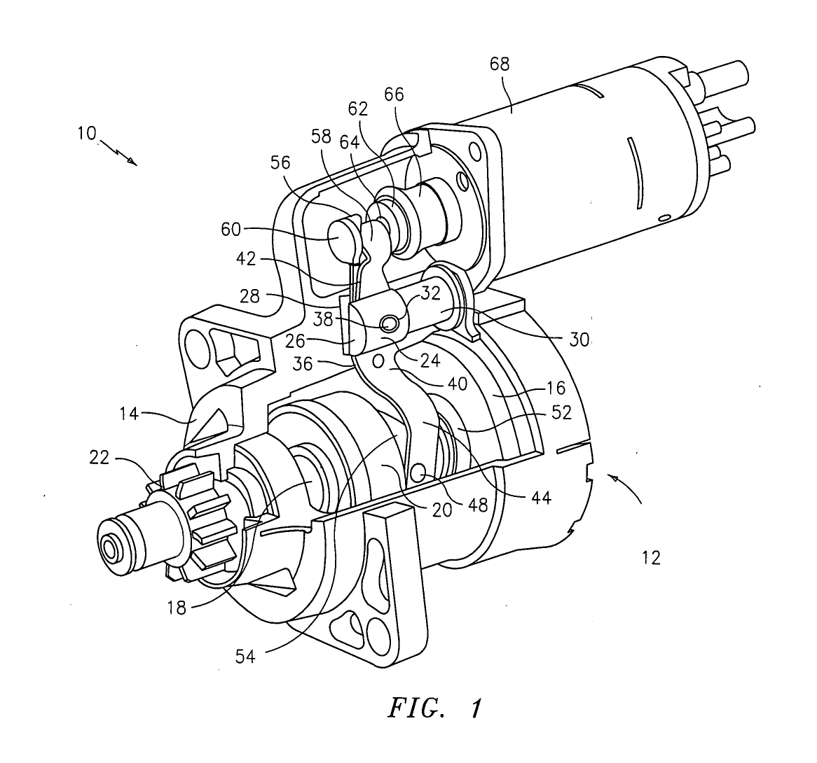

Shown in FIG. 1 is an embodiment of an improved starter motor 10. The starter motor 10 includes a drive assembly 12 at least partially disposed in a drive housing 14. The drive assembly 12 includes a pinion drive shaft 16. The pinion drive shaft 16 drives a starter drive 18 which comprises an overrunning clutch 20 and a pinion gear 22.

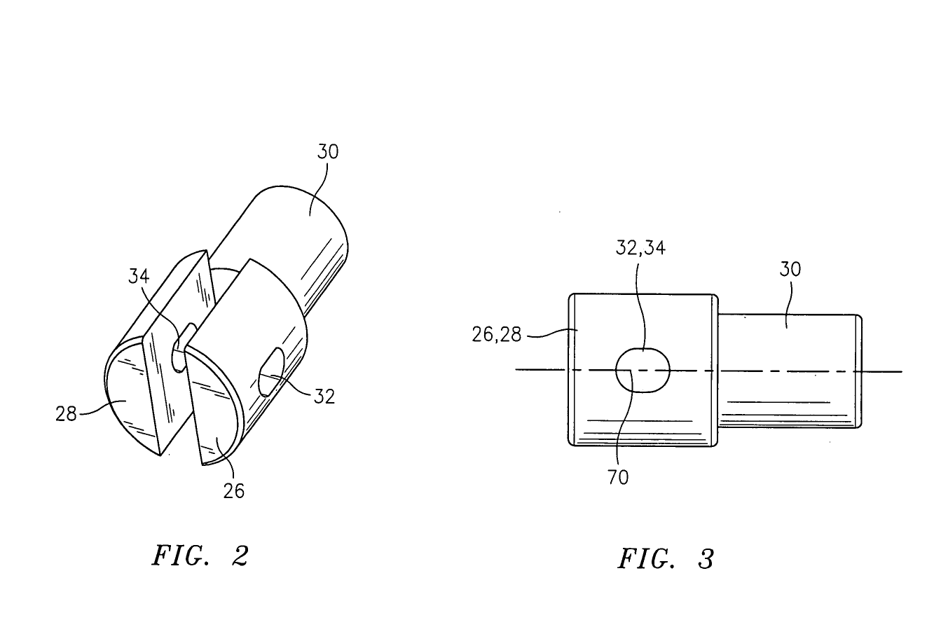

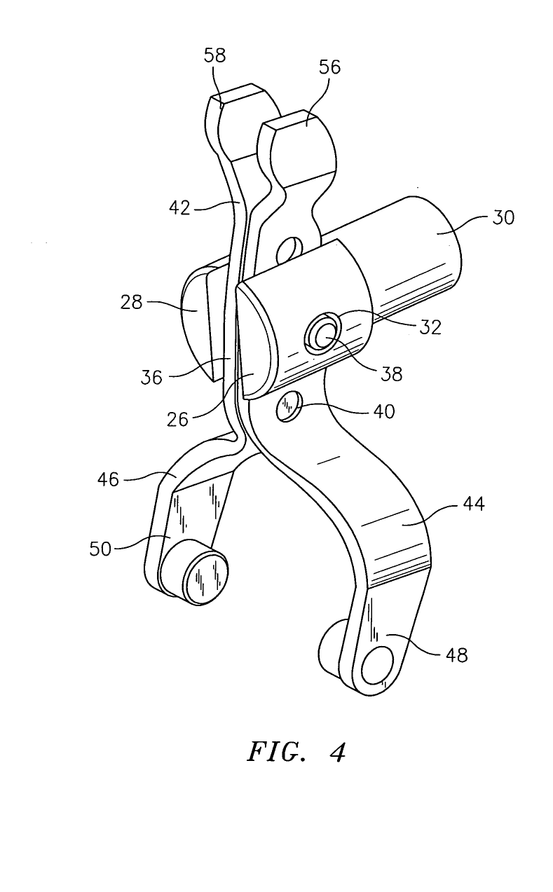

A shift lever plug 24 is disposed in the drive housing 14. An example of a shift lever plug 24 is shown in FIGS. 2-3 that includes opposed plug arms 26 and 28 that extend parallel to each other from an end portion 30. Plug arm 26 includes a first slot 32 that substantially aligns with a second slot 34 in plug arm 28. In the example shown in FIG. 3, the slots 32 and 34 are substantially oval shaped and extend in an axial direction, however the invention is not limited to slots of this shape and/or orientation.

Returning now to FIG. 1, the end portion 30 is fixed to the drive housing 14. A shift lever 36 is at least partially disposed between the plug arms 26 and 28. The shift lever 36 includes a pivot hole (not shown), which in some embodiments may be substantially circular. A pivot pin 38 is passed through the first slot 32, through the pivot hole and into the second slot 34, thus providing pivotal support for the shift lever 36. Because of the slotted configuration of the pivot pin 38 interface with the plug arms 26 and 28, there are multiple points at which the pivot pin 38 can be located axially in the first slot 32 and second slot 34, thus multiple points about which the shift lever 36 can pivot.

Referring now to FIG. 4, the shift lever 36 has two ends, a drive end 40 and a solenoid end 42. The drive end 40 comprises two drive arms 44 and 46. Drive arm 44 has a first drive arm end 48, and similarly drive arm 46 includes a second drive arm end 50. As shown in FIG. 1, drive arm ends 48 and 50 are located between disk 52 of the drive assembly 12 and surface 54 of the overrunning clutch 20. When shift lever 36 is rotated clockwise about pivot pin 38, drive arm ends 48 and 50 engage surface 54 of overrunning clutch 20 to push the overrunning clutch 20 and pinion gear 22 in an axial direction to a position where pinion gear 22 will mesh with a fly wheel (not shown) of an engine. Drive arm ends 48 and 50 are spaced sufficiently apart to effectively engage surface 54, and in the example shown in FIG. 4 are at circumferential positions about 180 degrees apart.

The solenoid end 42 includes two solenoid arms 56 and 58. The solenoid arms 56 and 58 are disposed between annular surfaces 60 and 62 of a shift lever actuator rod 64. In the example shown in FIG. 4, the solenoid arms 56 and 58 are disposed at circumferential locations about 180 degrees apart. An axial position of the rod 64 is controlled by a plunger 66 of a solenoid 68. When a coil (not shown) of the solenoid 68 is energized, the plunger 66 is depressed, causing the shift lever 36 to rotate in a clockwise direction (as viewed in FIG. 1) about pivot pin 38. The clockwise rotation of the shift lever 36 causes drive arm ends 48, 50 to engage surface 54 of overrunning clutch 20 to push the overrunning clutch 20 and pinion gear 22 in an axial direction to a position where pinion gear 22 will mesh with a fly wheel of an engine. When the coil of the solenoid 68 is deenergized, plunger 66 extends from the solenoid 68, returning to its rest position. As the plunger 66 extends, the shift lever 36 is pivoted about the pivot pin 38 in a counter-clockwise direction (as viewed in FIG. 1), causing pinion gear 22 to be moved out of mesh with the flywheel and back to its at-rest position.

Because the pivot pin 38 is disposed in the slots 32 and 34, there is more than one distinct point at which pivot pin 38 can be disposed along a longitudinal axis 70 of the slots 32 and 34, and thus more than one possible center of rotation of the shift lever 36. An actual location of the pivot pin 38 within the slots 32 and 34 of any one starter motor 10 is determined by, for example, variance in solenoid 68 manufacture, variance in drive assembly 12 manufacture, or variation in manufacture of other subcomponents of the starter motor 10. Allowing the location of the pivot pin 38 to vary depending on a variation in other components of the starter motor 10 allows the starter motor 10 to operate properly by, for example, ensuring proper engagement between the pinion gear 22 and the flywheel. The variance in the solenoid 68 manufacture and the drive assembly 12 manufacture can increase stresses on the shift lever 36, if the pivot pin 38 is restrained in a circular hole. Utilization of the slots 32 and 34 allows for variation in a location of the pivot pin 38 between starter motors 10, based on the variance in the manufacture of each starter motor 10. Allowing variation in the location of the pivot pin 38 reduces static stresses in the starter motor 10 while maintaining functionality of the starter motor 10.

While embodiments of the invention have been described above, it will be understood that those skilled in the art, both now and in the future, may make various improvements and enhancements which fall within the scope of the claims which follow. These claims should be construed to maintain the proper protection for the invention first described.

What is claimed is:

1. A starter motor comprising:
a housing;
a drive assembly disposed at least partially within the housing;
a solenoid;
a shift lever linking the drive assembly and the solenoid and in operable communication with a pivot pin; and
a shift lever plug receptive of the pivot pin and engageable with the housing, the shift lever plug including one or more slot features providing a plurality of pivot points for the shift lever.

2. The starter motor of claim 1 wherein the one or more slot features are disposed in one or more shift lever plug arms extending from a shift lever plug base.

3. The starter motor of claim 2 wherein the one or more shift lever plug arms is two shift lever plug arms, the shift lever being at least partially receivable therebetween.

4. The starter motor of claim 3 wherein the two shift lever plug arms are substantially parallel to each other.

5. The starter motor of claim 1 wherein the one or more through slot features are oval shaped.

6. The starter motor of claim 1 wherein a first end of the shift lever comprises two first end arms that are in operable communication with the drive assembly at diametrically opposed positions.

7. The starter motor of claim 1 wherein a second end of the shift lever comprises two second end arms that are in operable communication with the solenoid at diametrically opposed positions.

8. A starter motor comprising:
a housing;
a drive assembly disposed at least partially within the housing;
a solenoid;
a shift lever linking the drive assembly and the solenoid, the shift lever comprising:
a first end in operable communication with the drive assembly;
a second end in operable communication with the solenoid; and
a pivot hole;
a pivot pin insertable through the pivot hole in the shift lever; and
a shift lever plug receptive of the pivot pin and engageable with the housing, the shift lever plug including one or more slot features providing a plurality of pivot points for the shift lever.

9. The starter motor of claim 8 wherein the one or more slot features are disposed in one or more shift lever plug arms extending from a shift lever plug base.

10. The starter motor of claim 9 wherein the one or more shift lever plug arms is two shift lever plug arms, the shift lever being at least partially receivable therebetween.

11. The starter motor of claim 10 wherein the two shift lever plug arms are substantially parallel to each other.

12. The starter motor of claim 8 wherein the one or more through slot features are oval shaped.

13. The starter motor of claim 8 wherein a first end of the shift lever comprises two first end arms that are in operable communication with the drive assembly at diametrically opposed positions.

14. The starter motor of claim 8 wherein a second end of the shift lever comprises two second end arms that are in operable communication with the solenoid at diametrically opposed positions.

15. A shift lever plug for a starter motor comprising:
an end portion engageable with a housing; and
one or more slot features receptive of a pivot pin and providing a plurality of pivot points for a shift lever.

16. The shift lever plug of claim 15 wherein the one or more slot features are disposed in one or more shift lever plug arms extending from the end portion.

17. The shift lever plug of claim 16 wherein the one or more shift lever plug arms is two shift lever plug arms, the shift lever being at least partially receivable therebetween.

18. The shift lever plug of claim 17 wherein the two shift lever plug arms are substantially parallel to each other.

19. The shift lever plug of claim 15 wherein the one or more slot features are oval shaped.

20. A shift lever plug for a starter motor comprising:
a plug end engageable with a housing;
opposed plug arms extending from the plug end, the plug arms configured to be receptive therebetween of a shift lever of a starter motor; and
a plug slot disposed in each plug arm, the plug slot allowing a pivot pin to be inserted therethrough, the plug slot providing multiple pivot positions for the pivot pin.
